(19) United States
(12) Patent Application Publication
(10) Pub. No.: US 2016/0004632 A1
(43) Pub. Date: Jan. 7, 2016

(54) COMPUTING SYSTEM

(71) Applicants: INVENTEC (PUDONG) TECHNOLOGY CORPORATION, Shanghai (CN); INVENTEC CORPORATION, Taipei City (TW)

(72) Inventors: TIAN-WEN ZHAO, Shanghai City (CN); KUN LIU, Shanghai City (CN)

(21) Appl. No.: 14/456,962

(22) Filed: Aug. 11, 2014

(30) Foreign Application Priority Data
Jul. 4, 2014 (CN) 201410316919.1

(51) Int. Cl. G06F 12/02; G06F 9/44

(52) U.S. Cl. CPC G06F 12/0246; G06F 9/4401; G06F 2212/7201

(57) ABSTRACT

A computing system is adapted to be coupled with a storage device or a remote device and includes a logic module with a first firmware, a control module coupled with the storage device, a management module coupled with the control module and the logic module, and a central process unit (CPU). The storage device includes a second firmware and an operating system. The remote device includes the second firmware. The CPU is coupled with the control module and operates the operating system. When the CPU receives a burning instruction, the CPU burns the second firmware into the logic module through the control module and the management module.

### CROSS-REFERENCE TO RELATED APPLICATIONS

This non-provisional application claims priority under 35 U.S.C. §119 (a) on Patent Application No (s). 201410316919.1 filed in China on Jul. 4, 2014, the entire contents of which are hereby incorporated by reference.

### BACKGROUND OF THE INVENTION

1. Technical Field of the Invention

The disclosure relates to a computing system, and more particularly, to a computing system which is able to burn firmware into a logic module when a device is operating or is standby.

2. Description of the Related Art

In accordance with the advancement of the modern technology, the complexity of computing devices is increasing on a daily basis, and demands for the chip's functions are also incredibly soaring. If users need high complex computing ability, besides purchasing the most advanced chips, they may also update the firmware of the chips to fulfill that purpose.

However, it is still inconvenient to update the chip firmware. For example, in the past, if needing to update the chip's firmware, a client had to purchase the tool for firmware installation. Moreover, an installation technician had to shut down the client's computer or stop the hardware to be updated and then connected the installation technician's computer to the client's computer before burning the firmware into the chip. If the client's computer needs to consistently (uninterruptedly) operate, such a conventional update way will not work. Moreover, it is also a heavy load for the installation technician to travel to the client for updating the firmware every time.

### SUMMARY OF THE INVENTION

According to one or more embodiments, the disclosure provides a computing system. In one embodiment, the computing system is coupled with a storage device which stores an operating system and second firmware. The computing system comprises a logic module having first firmware, a control module coupled with the storage device, a management module coupled with the control module and the logic module, and a central processing unit (CPU) coupled with the control module and operating the operating system. After the CPU receives a burning instruction, the CPU burns the second firmware into the logic module through the control module and the management module.

In one of the above embodiments, the logic module comprises a non-volatile memory (NVRAM) and a volatile memory (VRAM). The first firmware is stored in the NVRAM. When the computing system is operating, the computing system operates the first firmware in the VRAM. When the CPU burns the second firmware into the logic module, the logic module overwrites the first firmware in the NVRAM by the second firmware and the computing system still operates the first firmware in the VRAM.

In one of the above embodiments, after the first firmware in the NVRAM is overwritten by the second firmware and when the computing system reboots, the computing system operates the second firmware in the VRAM.

In one of the above embodiments, the logic module is a complex programmable logic device (CPLD), the control module is a Platform Control Hub (PCH) chip, and the management module is a Baseboard Management Controller (BMC). The management module uses General Purpose Input Output (GPIO) signals to simulate Joint Test Action Group (JTAG) signals of the logic module, and the control module implements the read and write operations on the logic module through the management module. The logic module simulates the I²C port of the management module, so that the control module implements the read and write operations on the logic module through the management module.

In one of the above embodiments, the control module and the management module transmit signals by a Low pin count bus (LPC bus).

In one of the above embodiments, the computing system further comprises a display device coupled with the control module. The display device displays the working status of the computing system.

According one or more embodiments, the disclosure provides another computing system. In one embodiment, the computing system is coupled with a remote device which stores second firmware. The computing system comprises a logic module having first firmware, a management module coupled with the logic module, and a remote connecting module coupled with the remote device and the management module. After the remote device receives a burning instruction, the remote device burns the second firmware into the logic module through the remote connecting module and the management module.

In one of the above embodiments, the logic module is a CPLD, the management module is a BMC, and the remote connecting module comprises a RJ45 connector and a PHY chip.

In one of the above embodiments, the logic module comprises a NVRAM and a VRAM. The first firmware is stored in the NVRAM. When the computing system stops operating and after the remote device receives the burning instruction, the remote device makes the logic module overwrite the first firmware in the NVRAM by the second firmware through the remote connecting module and the management module.

In one of the above embodiments, the logic module comprises a NVRAM and a VRAM. The first firmware is stored in the NVRAM. When the computing system is operating, the computing system operates the first firmware in the VRAM. When the remote device makes the logic module overwrite the first firmware in the NVRAM by the second firmware through the remote connecting module and the management module, the computing system still operates the first firmware in the VRAM. After the first firmware in the NVRAM is overwritten by the second firmware and when the computing system reboots, the computing system operates the second firmware in the VRAM.

In one of the above embodiments, the computing system further comprises a control module, a CPU, and a display device. The control module is coupled with the management module, the CPU, and the display device. The display device displays the working status of the computing system, and the control module is a PCH chip.

In one of the above embodiments, the computing system further comprises a standby power module and a power supply module. The standby power module is coupled with the management module, the remote connecting module, and the logic module. The standby power module powers the management module, the remote connecting module, and the logic module for their normal operation. The power supply module is coupled with the control module. The power supply module powers the control module when being enabled.

In conclusion, the CPU of the computing system of the disclosure obtains the second firmware in the storage device (USB drive) in the storage module (USB) through the control module (PCH), and burns the second firmware into the NVRAM of the logic module after the management module (BMC) simulates the port connected to the logic module (CPLD). Because the logic module operates the first firmware in the VRAM, the burning of the second firmware does not affect the operation of the logic module. In this way, users can update the firmware of the logic module while the logic module still operates. Alternately, the computing system of the disclosure may also burn the second firmware outputted from a remote computer device to the NVRAM of the logic module through the remote connecting module and the management module.

### BRIEF DESCRIPTION OF THE DRAWINGS

The disclosure will become more fully understood from the detailed description given herein below for illustration only and thus does not limit the disclosure, wherein:

FIG. 1 is a functional block diagram of a computing system according to an embodiment of the disclosure.

FIG. 2 is a functional block diagram of a computing system according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

Trademark notification: Windows stands for the trademark of Microsoft Corporation; Linux stands for the trademark of Linus Torvalds; and Lattice and TransFR stand for the trademarks of Lattice Semiconductor Corporation.

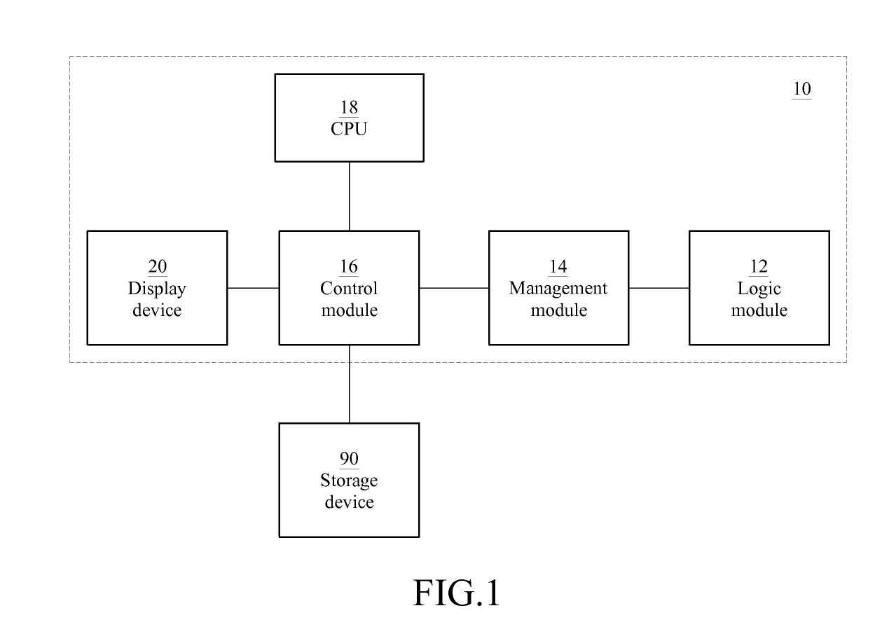

Please refer to FIG. 1. FIG. 1 is a functional block diagram of a computing system according to an embodiment of the disclosure. As shown in FIG. 1, a computing system 10 comprises a logic module 12, a management module 14, a control module 16, and a central processing unit (CPU) 18.

The computing system 10 is coupled with a storage device 90 which stores an operating system and second firmware. The storage device 90 may be any device which is able to be coupled with the computing system and has a storage space, including but not limited to one ore more USB drives, floppy disks, hard disk drives, memory cards, flash memory cards, secure digital memory cards, and mini SD (or micro SD) cards. The aforementioned operating system may include but not limited to the Disk Operating System (DOS), Linux OS, and Windows OS.

The logic module 12 has second firmware and may operate the second firmware. The control module 16 is coupled with the storage device 90. The management module 14 is coupled with the control module 16 and operates the operating system. After the CPU 18 receives a burning instruction, the CPU 18 burns the second firmware into the logic module 12 through the control module 16 and the management module 14.

For clearer explanation, the aforementioned modules are exemplified as follows but not limited to the examples.

The aforementioned logic module 12 is a complex programmable logic device (CPLD), the control module 16 is a Platform Control Hub (PCH), and the management module 14 is a Baseboard Management Controller (BMC).

The logic module 12 may include but not be limited to a CPLD with the TransFR technology of Lattice Corporation. The logic module 12 comprises a non-volatile memory (NVRAM) and a volatile memory (VRAM). The VRAM may include but not be limited to a Dynamic Random Access Memory (DRAM) or Static Random Access Memory (SRAM). The NVRAM may include but not be limited to a Read-only Memory (ROM) or Flash Memory.

The aforementioned first firmware is stored in the NVRAM. When the computing system 10 is operating, the computing system 10 operates the first firmware in the VRAM. When the CPU 18 is burning the second firmware into the logic module 12, the logic module 12 overwrites the first firmware in the NVRAM by the second firmware and the computing system 10 is still operating the first firmware in the VRAM. After the first firmware in the NVRAM is overwritten by the second firmware and when the computing system 10 reboots, the computing system 10 operates the second firmware in the VRAM. Consequently, the computing system 10 is able to update the firmware of the logic module 12 while being not shut down and maintaining its current operation (even maintaining its original I/O status).

The aforementioned control module 16 is coupled with the management module 14. As previously-described, taking the PCH as the control module 16 and the BMC as the management module 14 for an example, the control module 16 communicates with the management module 14 by the Low pin count bus (LPC bus).

Then, the management module 14 is coupled with the logic module 12 and communicates with the logic module 12. As previously-described, taking a BMC as the management module and a CPLD as the logic module for an example, the management module 14 may use General Purpose Input Output (GPIO) signals to simulate Joint Test Action Group (JTAG) signals of the logic module, and the control module 16 implements the read and write operations on the logic module 12 through the management module 14.

In addition, as previously-described, taking a BMC as the management module and a CPLD as the logic module for an example, when the management module 14 includes a plurality of I²C ports, the logic module 12 can also simulate the I²C ports of the management module 14 to update or burn the firmware.

The computing system 10 further comprises a display device 20. The display device 20 is coupled with the control module 16 to display the working status of the computing system 10. For example, when the computing system 10 is operating (the CPU 18 is operating the operating system in the storage device 90), all the working statuses can be shown to the operators through the display device 20.

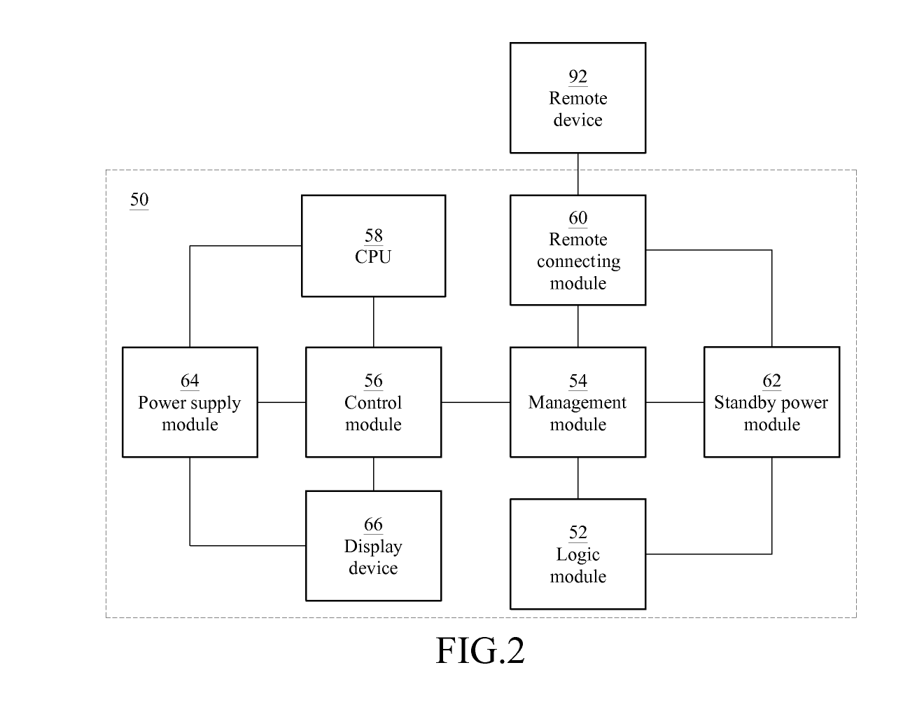

Please continuously refer to FIG. 2. FIG. 2 is a functional block diagram of a computing system according to another embodiment of the disclosure.

A computing system 50 is coupled with a remote device 92 which stores second firmware. The computing system 50 comprises a logic module 52, a management module 54, and a remote connecting module 60.

The logic module 52 has first firmware and may include but not be limited to a CPLD. The management module 54 is coupled with the logic module 52 and may include but not be limited to a BMC. The remote connecting module 60 is coupled with remote device 92 and the management module 54. The remote connecting module 60 comprises a RJ45 connector and a PHY chip.

After the remote device 92 receives a burning instruction, the remote device 92 burns the second firmware into the logic module 52 through the remote connecting module 60 and the management module 54.

The logic module 12 may include but not be limited to a CPLD with TransFR technology of Lattice Corporation. The logic module 12 comprises a NVRAM and a VRAM and the first firmware is stored in the NVRAM. When the computing system 50 is not operating and after the remote device 92 receives the burning instruction, the remote device 92 makes the logic module 52 overwrite the first firmware in the NVRAM by the second firmware through the remote connecting module 60 and the management module 54. Consequently, the computing system 50 is able to update the firmware of the logic module 52 while being not shut down and maintaining its current operation (even maintaining its original I/O status).

Then, when the computing system 50 is operating, the computing system 50 operates the first firmware in the VRAM. When the remote device 92 makes the logic module 52 overwrite the first firmware in the NVRAM by the second firmware through the remote connecting module 60 and the management module 54, the computing system 50 still operates the first firmware in the VRAM. After the first firmware in the NVRAM is overwritten by the second firmware and when the computing system 50 reboots (reboot), the computing system 50 operates the second firmware in the VRAM.

Further, as previously-described, the management module 54 can simulate the JTAG signals of the logic module 52 by the GPIO. Therefore, the remote device 92 can implement the read and write operations on the logic module 52 through the management module 54.

In another embodiment, the logic module 52 can simulate the I²C ports of the management module 54, so that the remote device 92 can implement the read and write operations on the logic module 52 through the management module 54.

In an embodiment, the computing system 50 may comprise a control module 56, a CPU 58, and a display device 66. The control module 56 is coupled with the management module 54, the CPU 58, and the display device 66. The display device 66 displays the working status of the computing system 50. The control module 56 may include but not be limited to a PCH. The aforementioned control module 56 and the management module 54 may transmit signals by the Low pin count bus (LPC bus).

The computing system 50 may further comprise a standby power module 62 and a power supply module 64. The standby power module 62 is coupled with the management module 54, the remote connecting module 60, and the logic module 52. The standby power module 62 powers the management module 54, the remote connecting module 60, and the logic module 52 such that the management module 54, the remote connecting module 60, and the logic module 52 can normally operate.

The power supply module 64 is coupled with the control module 56, the CPU 58, and the display device 66. When the power supply module 64 is powered, the power supply module 64 powers the control module 56, the CPU 58, and the display device 66.

Therefore, when the standby power module 62 is operating but the power supply module 64 is not, the computing system 50 is in a standby status. At this very moment, the CPU 58, the control module 56, and the display device 66 do not operate but the remote device 92 is still able to perform read and write operations or firmware updating to the logic module 52.

In conclusion, according to an embodiment of the disclosure, the computing system 10 includes the CPU 18 which operates the operating system in the storage device 90, and the CPU 18 can overwrite the first firmware in the NVRAM of the logic module 12 by the second firmware in the storage device 90 through the control module 16 and the management module 14 to update the firmware of the logic module 12. According to another embodiment of the disclosure, the remote device coupled with the computing system 50 can update the firmware of the logic module 52 through the remote connecting module 60 and the management module when the computing system 50 does not operate. In other words, users may perform read and write operation or firmware updating to the logic module without booting up the computing system 50.

What is claimed is:

1. A computing system adapted to be coupled with a storage device which stores an operating system and second firmware, comprising:
a logic module having first firmware;
a control module coupled with the storage device;
a management module coupled with the control module and the logic module; and
a central processing unit (CPU) coupled with the control module, for operating the operating system,
wherein after the CPU receives a burning instruction, the CPU burns the second firmware into the logic module through the control module and the management module.

2. The computing system of claim 1, wherein the logic module is a complex programmable logic device (CPLD), the control module is a Platform Control Hub (PCH), and the management module is a Baseboard Management Controller (BMC).

3. The computing system of claim 2, wherein the logic module comprises a non-volatile memory (NVRAM) and a volatile memory (VRAM); the first firmware is stored in the NVRAM; when the computing system is operating, the computing system operates the first firmware in the VRAM; and when the CPU burns the second firmware into the logic module, the logic module overwrites the first firmware in the NVRAM by the second firmware and the computing system continues operating the first firmware in the VRAM.

4. The computing system of claim 3, wherein after the first firmware in the NVRAM is overwritten by the second firmware and when the computing system reboots, the computing system operates the second firmware in the VRAM.

5. The computing system of claim 2, wherein the control module and the management module transmit signals by a Low pin count bus (LPC bus).

6. The computing system of claim 2, wherein the management module uses General Purpose Input Output (GPIO) signals to simulate Joint Test Action Group (JTAG) signals of the logic module, and the control module implements read and write operations on the logic module through the management module.

7. The computing system of claim 2, wherein the logic module simulates I²C port of the management module, so that the control module implements read and write operations on the logic module through the management module.

8. The computing system of claim 1, further comprising a display device coupled with the control module and configured to display the working status of the computing system.

9. A computing system adapted to be coupled with a remote device which stores second firmware, comprising:
a logic module having first firmware;
a management module coupled with the logic module; and
a remote connecting module coupled with the remote device and the management module,
wherein after the remote device receives a burning instruction, the remote device burns the second firmware into the logic module through the remote connecting module and the management module.

10. The computing system of claim 9, wherein the logic module is a CPLD, the management module is a BMC, and the remote connecting module comprises a RJ45 connector and a PHY chip.

11. The computing system of claim 10, wherein the logic module comprises a NVRAM and a VRAM; the first firmware is stored in the NVRAM; when the computing system is not operating and after the remote device receives the burning instruction, the remote device makes the logic module overwrite the first firmware in the NVRAM by the second firmware through the remote connecting module and the management module.

12. The computing system of claim 10, wherein the logic module comprises a NVRAM and a VRAM; the first firmware is kept in the NVRAM; when the computing system is operating, the computing system operates the first firmware in the VRAM; and when the remote device makes the logic module overwrite the first firmware in the NVRAM by the second firmware through the remote connecting module and the management module, the computing system still operates the first firmware in the VRAM.

13. The computing system of claim 12, wherein after the first firmware in the NVRAM is overwritten by the second firmware and when the computing system reboots, the computing system operates the second firmware in the VRAM.

14. The computing system of claim 10, wherein the management module uses GPIO signals to simulate JTAG signals of the logic module, and the remote connecting module implements read and write operations on the logic module through the management module.

15. The computing system of claim 10, wherein the logic module simulates I²C port of the management module, so that the remote connecting module implements read and write operations on the logic module through the management module.

16. The computing system of claim 10, further comprising a control module, a CPU, and a display device; the control module is coupled with the management module, the CPU, and the display device; the display device is configured to display the working status of the computing system; and the control module is a Platform Control Hub (PCH).

17. The computing system of claim 16, wherein the control module and the management module transmit signals by a LPC bus.

18. The computing system of claim 16, further comprising:
a standby power module coupled with the management module, the remote connecting module, and the logic module, for powering the management module, the remote connecting module, and the logic module to support the operation of the management module, the remote connecting module and the logic module; and
a power supply module coupled with the control module, for powering the control module when being enabled.
